(19) United States
(12) Patent Application Publication
(10) Pub. No.: US 2025/0359574 A1
(43) Pub. Date: Nov. 27, 2025

(54) COMPOSITION OF AND METHOD OF EXTRACTION OF ULVA GEL FROM SEAWEED POLYSACCHARIDE AND PROTEIN

(71) Applicant: Blue Evolution Inc., Los Altos, CA (US)

(72) Inventors: Zach PITTMAN, Los Altos, CA (US); Gowri SHAH, Los Altos, CA (US); Beau G. PERRY, Los Altos, CA (US)

(73) Assignee: Blue Evolution Inc., Los Altos, CA (US)

(21) Appl. No.: 19/214,848

(22) Filed: May 21, 2025

Related U.S. Application Data
(60) Provisional application No. 63/650,533, filed on May 22, 2024.

(51) Int. Cl. A23L 17/60; A23L 27/00; A23L 27/12; A23L 27/40

(52) U.S. Cl. CPC A23L 17/60; A23L 27/13; A23L 27/40; A23L 27/82

(57) ABSTRACT

Disclosed are Ulva gel compositions and methods of making thereof, and nutraceutical formulations containing the gels.

### BACKGROUND OF THE DISCLOSURE

This application claims the benefit of priority under 35 U.S.C. § 119(e) to U.S. Provisional Application No: 63/650,533, filed May 22, 2024, which is incorporated herein by reference in its entirety.

### BACKGROUND OF THE DISCLOSURE

Food insecurity is a significant global issue and will only worsen as climate change and population growth continue to push the limits of the strained food production systems, and approximately one out of nine people worldwide are suffering from malnutrition. (Diaz et al., Front. Nutr. 9:1029841 (2023)). However, traditional terrestrial agriculture systems also contribute to climate change by depleting topsoil, water resources, natural habitats, and contributing to nutrient pollution in groundwater (Mateo-Sagasta et al., Water Pollution from Agriculture: A Global Review, Rome: The Food and Agriculture Organization, pp. 1-35 (2017), Rome, Italy).

Amidst the quest for sustainable food sources, the spotlight is increasingly turning towards the vast potential of seaweed. Seaweed cultivation offers a promising avenue for sustainable biomass production, requiring no arable land, freshwater, or chemical inputs. By leveraging 100% renewable energy sources and maximizing seaweed's carbon uptake, the supply chain can yield carbon-negative outputs which may have obvious environmental and planetary benefits. Harnessing the diverse applications of seaweed has emerged as a promising avenue to reduce the ecological footprint created by agriculture.

Therefore, new nutritional food sources that do not further impact the environment are urgently needed.

### SUMMARY OF THE DISCLOSURE

The Ulva gel compositions and Ulva gels disclosed herein are expected to address one or more of the above needs.

A first aspect of the present disclosure is directed to a Ulva composition, in the form of a gel (also referred to herein as the Ulva gel composition or the Ulva gel), wherein the gel is made by a process, including: (a) mixing Ulva with water thereby producing an aqueous Ulva composition, wherein the Ulva comprises at least about 1 dry weight percent (wt %) based on the total weight of the aqueous Ulva composition; (b) heating the aqueous Ulva composition at a temperature of about 100° C. to about 135° C., and at a pressure of about 5 pounds per square inch gauge (PSIG) to about 30 PSIG; (c) optionally filtering and/or centrifuging the resultant aqueous Ulva composition; and (d) cooling the aqueous Ulva composition of step (b) or (c), thereby forming the Ulva gel composition.

In some embodiments, the Ulva is in dry form (e.g., milled to form an Ulva powder) before mixing the Ulva with water to produce the aqueous Ulva composition. In some embodiments, the Ulva is in wet form (e.g., freshly harvested without further processing). The wet Ulva and water may be homogenized (e.g., with a blender) to form the aqueous Ulva composition. In some embodiments, the Ulva is freshly harvested. In some embodiments, the Ulva is stored after harvesting.

In some embodiments, the Ulva comprises from about 1 to about 14 dry wt % based on the total weight of the aqueous Ulva composition. In some embodiments, the Ulva comprises about 8 dry wt % based on the total weight of the aqueous Ulva composition.

In some embodiments, the Ulva is treated with ethanol prior to mixing with water.

In some embodiments, the heating temperature is about 120° C. In some embodiments, the heating pressure is about 20 PSIG. In some embodiments, the heating is performed for about 20 minutes.

In some embodiments, the Ulva gel composition contains an additive. In some embodiments, the additive is a flavorant, a salt (also referred to herein as a “mineral”), a colorant, a preservative, a plant extract, an algal extract, a bacterial extract, or a fungal extract. In some embodiments, the flavorant is a natural flavorant. In some embodiments, the natural flavorant is lemon, lime, vinegar, or a combination of two or more thereof. In some embodiments, the colorant is a natural pigment. In some embodiments, the natural pigment is from Ulva or another plant-based (e.g., seaweed) source. In some embodiments, the natural pigment is obtained from one or more of spinach, beetroot, and blackberries.

In some embodiments, the salt is boron, calcium chloride, sodium chloride, potassium chloride, calcium carbonate, magnesium sulfate, sodium bicarbonate, potassium nitrate, sodium sulfate, calcium carbonate, potassium hydroxide, magnesium chloride, ammonium chloride, sodium carbonate, calcium phosphate, potassium sulfate, magnesium carbonate, potassium carbonate, calcium sulfate, ammonium nitrate, sodium nitrate, or a combination thereof. In some embodiments, the salt is boron at about 0.001 to about 0.05% based on the total weight of the aqueous Ulva composition.

As a result of the heating under pressure (also referred to herein as autoclaving or pressure-assisted extraction), the Ulva gel composition contains Ulva solids that include, at a minimum, Ulva polysaccharides such as Ulvan. In addition to contributing to gel formation, Ulva polysaccharides may further enhance one or more additional properties of the Ulva gel compositions, such as moisture content, rheology (strength, temperature dependence, pH dependence, viscosity, elasticity and syneresis), nutrition, syneresis, antioxidant activity, and bioactivity.

In some embodiments, the Ulva gel composition contains one or more additional Ulva solids such as proteins, fats, minerals (i.e., salts), pigments, phytochemicals, and inorganics. In some embodiments, the Ulva gel composition has a solids content of about 0.2 to about 10% based on the total weight of the composition. The amount of Ulva solids in the gel is referred herein as the “solids content.” The content of the Ulva solids may differ from that of the Ulva starting material due to the process of heating and optionally filtering and/or centrifuging.

In some embodiments, the Ulva gel has a gel strength of about 1 to about 350 gram Bloom.

Another aspect of the present disclosure is directed to a nutraceutical containing the Ulva gel composition. In some embodiments, the nutraceutical is formulated for topical use such as by way of a cream, an ointment, a paste, or a lotion. In some embodiments, the nutraceutical is formulated for ingestible use, such as by way of a pill, a gummy, a capsule, a caplet, a sprinkle capsule, a softgel, or a tablet. In some embodiments, the tablet is a chewable tablet, an oral disintegrating tablet, a sublingual tablet, an effervescent tablet, or a buccal tablet.

Another aspect of the present disclosure is directed to a container containing the Ulva gel composition or the nutraceutical. In some embodiments, the container is a jar, a bag, or a tube.

Yet another aspect of the present disclosure is directed to a process of producing an Ulva composition in the form of a gel. The process entails (a) mixing Ulva with water thereby producing an aqueous Ulva composition, wherein the Ulva comprises at least about 1 dry wt % based on the total weight of the aqueous Ulva composition; (b) heating the aqueous Ulva composition at a temperature of about 100° C. to about 135° C., and at a pressure of about 5 PSIG to about 30 PSIG; (c) optionally filtering and/or centrifuging the resultant aqueous Ulva composition; and (d) cooling the aqueous Ulva composition of step (b) or (c), thereby forming the Ulva gel composition.

The Ulva gel compositions disclosed herein are biodegradable and therefore, eco-friendly, in that their production, use, and disposal will all result in low environmental impact. Water is a direct ingredient in the Ulva gel; however, the supply chain and methods of production may be substantially freshwater-free. Therefore, the overall amount of water consumed to produce the Ulva gel may be lower than other comparable food ingredients.

Also, the Ulva gel compositions are intended to replace traditional products made from terrestrial agricultural sources. The Ulva polysaccharides are readily and inexpensively extractable from renewable natural sources, namely green algae, and in commercially viable quantities. The gel compositions are biodegradable and will break down naturally over time, without causing harm to the environment.

Further, and beyond its role as a sustainable food source, like other seaweed, Ulva boasts a plethora of health and wellness benefits. Rich in vitamins, minerals, and antioxidants, seaweed is increasingly recognized for its nutraceutical properties, promoting overall health and vitality. Moreover, seaweed bioactive compounds have found applications in cosmeceuticals, contributing to skincare formulations renowned for their moisturizing, anti-inflammatory, and anti-aging effects.

Even further, the present disclosure may incentivize local operators in coastal communities to convert commercial seaweed crops into a range of valuable, climate-smart products, accommodating different potential configurations and production scales. This capability will foster local economic growth and resilience in coastal communities, facilitate market access for new seaweed farmers, and stimulate the creation of new jobs and investments in local seaweed supply chain enterprises. This encompasses activities such as seed production, farming, processing, logistics, and support from vendors and service providers.

### BRIEF DESCRIPTION OF THE DRAWINGS

FIG. 1 is a schematic illustrating two methods known in the art of ulvan extraction and purification.

FIG. 2 is a set of chemical structures illustrating aldobiuronic acids and ulvanobioses disaccharide repeating units of ulvan.

FIGS. 3A-3B are a set of line plots showing properties of Ulva gels. FIG. 3A is a line plot that shows extraction solid percentage of gels produced with and without pressure-assisted extraction. FIG. 3B is a line plot that shows relative gel strength of gels produced with and without pressure-assisted extraction.

FIG. 4 is a line plot comparing two methods of Ulva gel preparation.

FIG. 5 is a line plot comparing gel strengths as a function Ulva powder content.

FIG. 6 is a schematic illustrating two methods of Ulva gel preparation.

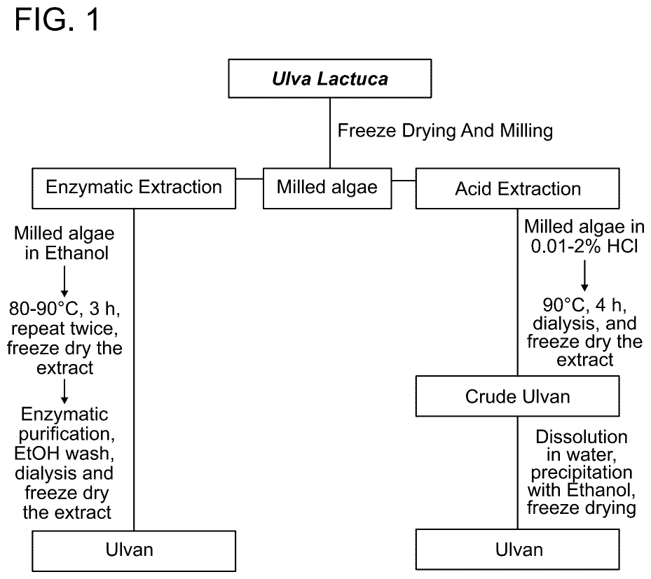

### DETAILED DESCRIPTION OF THE DISCLOSURE

Unless defined otherwise, all technical and scientific terms used herein have the same meaning as is commonly understood by one of skill in the art to which the subject matter herein belongs. As used in the specification and the appended claims, unless specified to the contrary, the following terms have the meaning indicated to facilitate the understanding of the present disclosure.

As used in the description and the appended claims, the singular forms “a”, “an”, and “the” mean “one or more” and therefore include plural referents unless the context clearly dictates otherwise. Thus, for example, reference to “a composition” includes mixtures of two or more such compositions, reference to “an Ulva powder” includes mixtures of two or more such powders, and the like.

Unless stated otherwise, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term “about.”

The transitional term “comprising,” which is synonymous with “including,” “containing,” or “characterized by,” is inclusive or open-ended and does not exclude additional, unrecited elements or method steps. By contrast, the transitional phrase “consisting of” excludes any clement or method step not specified in the claim (or the specific element or method step with which the phrase “consisting of” is associated). The transitional phrase “consisting essentially of” limits the scope of a claim to the specified elements and method or steps and “unrecited elements and method steps that do not materially affect the basic and novel characteristic(s)” of the claimed disclosure.

### Ulva Gel Compositions

In one aspect, the disclosure provides an Ulva composition in the form of a gel. As is known in the art, a gel is a composition in which solid particles are meshed within the composition such that a rigid or semi-rigid mixture results.

Ulva (Phylum Chlorophyta, Class Ulvophyceae, Order Ulvales, Family Ulvaceae) is a genus of green algae widely distributed throughout the world. Ulva species are primarily marine taxa found in saline and salty waters, but some Ulva species can also proliferate in freshwater habitats. Ulva species are commonly referred to as sea lettuce.

The Ulva gel compositions of the present disclosure may be prepared by a process that includes: (a) mixing Ulva with water thereby producing an aqueous Ulva composition, wherein the Ulva comprises at least about 1 dry weight percent (wt %) based on the total weight of the aqueous Ulva composition; (b) heating the aqueous Ulva composition at a temperature of about 100° C. to about 135° C., and at a pressure of about 5 pounds per square inch gauge (PSIG) to about 30 PSIG (also referred to herein as autoclaving or pressure-assisted extraction); (c) optionally filtering and/or centrifuging the resultant aqueous Ulva composition; and (d) cooling the aqueous Ulva composition of step (b) or (c), thereby forming the Ulva gel composition.

The type of Ulva species is not critical. In some embodiments, the Ulva is Ulva lactuca, U. fasciata, U. ohnoi, U. prolifera, U. Armoricans, U. australis, U. rigida, U. linza, U reticulata, U. ralfsii, U. compressa, U. pertusa, U. intestinalis, U. flexuosa, U. californica, U. curvata, U. digitata, U. clathrate, U. scandinavica, U. adhaerens, U. spathulate, or a combination of two or more thereof. In some embodiments, the Ulva is U. ohnoi, U. australis, U. ralfsii, or a combination of two or more thereof. In some embodiments, the Ulva is U. ohnoi.

The source and/or location from which the Ulva is sourced is not critical. In some embodiments, the Ulva is grown in a confined, controlled environment, also referred herein as farmed Ulva (e.g., grown in tanks or ponds). In some embodiments, the Ulva is harvested from a natural maritime source. In some embodiments, the Ulva starting material is produced from an Ulva obtained from the Pacific Ocean, the Atlantic Ocean, the Southern Ocean, the Indian Ocean, the Arctic Ocean, or a combination of two or more thereof. In some embodiments, the Ulva is obtained from a shallow coastal region (e.g., a lagoon).

In some embodiments, the Ulva is obtained during a hemispheric summer month. In some embodiments, the summer month is June, July, August, or September (i.e., Northern Hemisphere summer months). In some embodiments, the summer month is December, January, February, or March (i.e., Southern Hemisphere summer months). In some embodiments, the Ulva is obtained during an autumn (i.e., fall) month or a spring month. In some embodiments, the autumn month is September, October, or November (i.e., Northern Hemisphere autumn months). In some embodiments, the autumn month is March, April, or May (i.e., Southern Hemisphere autumn months). In some embodiments, the Ulva is obtained during a spring (i.e., fall) month or a spring month. In some embodiments, the autumn month is March, April, or May (i.e., Northern Hemisphere spring months). In some embodiments, the autumn month is September, October, or November (i.e., Southern Hemisphere spring months).

The term “milling” as used herein includes washing, tempering, grinding, pulverizing, trashing, crushing, digesting, or a combination of two or more techniques thereof of dried Ulva.

The Ulva starting material contains, among other native constituents, gel-forming polysaccharides. The term “Ulva polysaccharide” is used herein to broadly refer to polysaccharides that have a molecular structure chiefly or entirely made up of monosaccharide units bonded together that originate from Ulva. Representative examples of gel-forming Ulva polysaccharides that may be present in the Ulva starting material include, for example, ulvan, starch, cellulose, xyloglucan, glucuronan, and combinations of two or more thereof. Generally, gel-forming Ulva polysaccharides constitute about 30 wt % to about 85 wt % based on the total weight of the Ulva starting material.

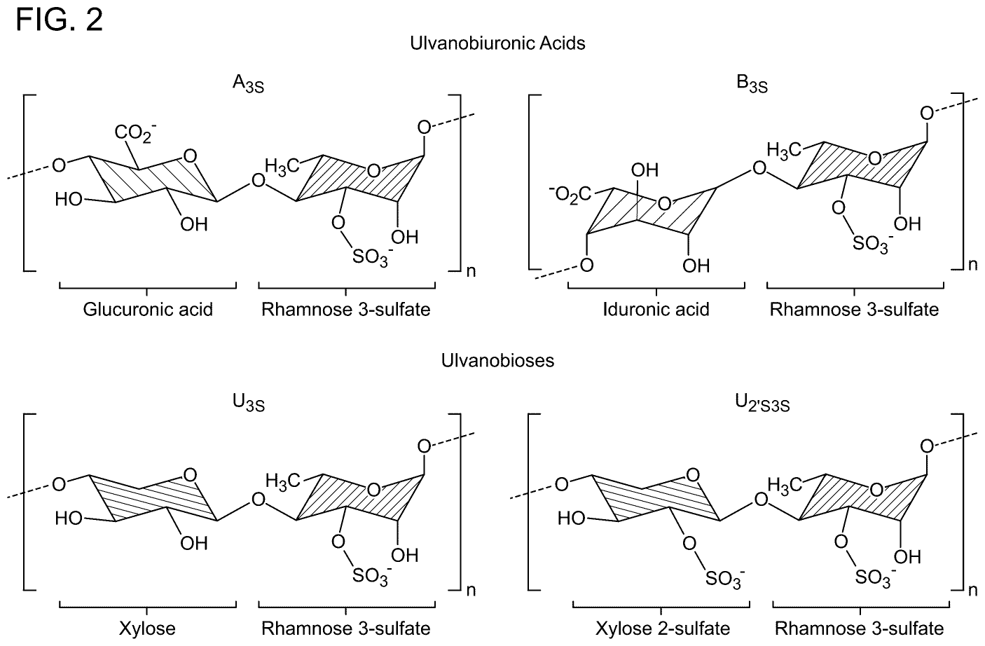

Ulvans are cell wall polysaccharides that may constitute about 10% to about 45% dry weight of the Ulva starting material. The quantitative yield and the quality of ulvan can vary significantly depending on the Ulva species, location, cultivation technique (wild or cultivated), storage, pre-extraction process, and extraction process. In some embodiments, the Ulva starting material contains about 20% to about 35% ulvan. The Ulvan may have a molecular weight in the range of about 5 kDa to about 2,500 kDa and a degree of sulfation of about 9% to about 35%. The chemical structures of the major and minor disaccharide repeating units are illustrated in FIG. 2. See, e.g., Tziveleka et al., Carbohydr. Polym. 218:355-370 (2019); Lakshmi et al., Biomolecules 10(7):991-20 (2020); Wahlström et al., Carbohydr Polym. 233:115852-9 (2020); Amor et al., Biomass Conversion and Biorefinery 13:3975-3985 (2023) and U.S. Patent Application Publication No. 2022/0289999.

Ulvans isolated from blade Ulva species have been reported to have a higher sulfate ester content (and therefore higher overall sulfate content) than filamentous Ulva species. The degree of sulfation in ulvan has previously been correlated with anticoagulant, antihyperlipidemic and anti-viral activity. Therefore, ulvans isolated from blade and filamentous Ulva species may have different bioactivities. The degree of sulfation is also likely to affect the solution properties of ulvan (e.g., rheology). As the degree of sulfation of ulvan increases, the viscosity of a ulvan-containing composition also increases. Ulva gel compositions with increased viscosity may enhance the workability and improving the gel's ability to mix, and form. Therefore, Ulva starting materials sourced from a blade Ulva species may have higher sulfate content than Ulva starting materials sourced from filamentous Ulva species and may be used in Ulva gel compositions where increased viscosity and workability are advantageous.

Starch is a polysaccharide that serves as an energy storage molecule in Ulva. Ulva contains up to about 30% of starch by dry weight. The thermo-chemical properties of Ulva starch are described in, for example, Prabhu et al., Algal Research 37:215-227 (2019). The main component of the Ulva cell-wall is cellulose. Ulva contains up to about 30% of cellulose by dry weight. See, Halib et al., Materials (Basel). 10(8):977 (2017), Wahlström et al., Cellulose 27:3707-3725 (2020), and El-Sheekh et al., Sci. Rep. 13(1):10188 (2023).

Additional Ulva solids that may be present in the Ulva starting material include any one or more of Ulva proteins, minerals (also referred herein as salts), fats, pigments, phytochemicals, and inorganics. The term “Ulva protein” is used herein to broadly refer to molecules composed of one or more chain of amino acids that originate from Ulva.

As persons skilled in the art would readily appreciate, since autoclaving (and any one or more of the attendant conditions of time, temperature, and pressure) might cause or lead to alterations in the solids present in the Ulva starting material, the profile of the Ulva solid(s) e.g., polysaccharides and other solids such as proteins, in the Ulva gel may differ from the profile of Ulva solids in the starting material.

The Ulva used in the disclosed processes may be freshly harvested or stored until use. It may be used in wet or dry form. Wet Ulva may be homogenized. In some embodiments, homogenization is conducted using a blender, such that the wet Ulva is homogenized with water to make a solution or dispersion. The homogenization may result in an aqueous Ulva composition containing no Ulva particle larger than about 300 microns in any dimension. Dried Ulva may be milled (which forms an Ulva powder), flaked, or used in full form. In some embodiments, the harvested Ulva (wet or in dry form) is stored, typically at about room temperature, e.g., about 15 to about 25° C. In some embodiments, the Ulva is stored at a typical refrigeration (non-freezing) temperature, e.g., about 2° C. to about 6° C. In some embodiments, the Ulva is stored for a time period of about 1 week to about 3 years. In some embodiments, the Ulva is stored in a sealed container. In some embodiments, the sealed container is opaque.

In some embodiments, the Ulva (in either wet or dry form) is treated with ethanol prior to heating. In some embodiments, the Ulva is added to an ethanol solution with about 10 to about 100 wt % ethanol at temperatures from about 20 to about 80° C. under ambient pressure (about 0pounds per square inch gauge (PSIG)) and mixed for about 1 to about 60 minutes. Alternatively, or in addition, in some embodiments, ethanol is continuously percolated through the Ulva and recovered by means of an evaporation and condensation cycle (e.g., Soxhlet extraction). Ethanol-treated Ulva may then be filtered and rinsed with deionized water, tap water, or seawater using about 1 to about 20 times volume of water to ethanol solution. Solids and liquid separation during the rinsing may be performed in accordance with known methods. In some embodiments, the separation is conducted gravimetrically using suitable filters and optionally accelerated by applying positive pressure before the filter or negative pressure after the filter. In some embodiments, the separation is conducted using centrifugal techniques.

In some embodiments, Ulva pigments may be removed prior to the pressure-assisted extraction, especially in embodiments wherein the resultant gel composition is intended to be relatively clear or if another color is desired. Ulva pigment removal may be performed in accordance with known methods. In some embodiments, pigments are removed during the ethanol treatment step. In some embodiments, the Ulva powder is treated with an organic solvent (e.g., an acetone and methanol solution or an acetone and butylated hydroxytoluene solution) or an activated aqueous solution. See, e.g., Merdekawati et al., IOP Conf. Ser.: Earth Environ. Sci., 306:012011 pp. 1-6 (2019); Silva et al., Mar Drugs 17(2):90 pp. 1-7 (2019), Pinheiro e, Molecules 24(16):2955 pp. 1-11 (2019), and Martins et al., Separation and Purification Technology 254:117589, pp. 1-7 (2021).

The term “aqueous Ulva composition” as used herein refers to Ulva in an aqueous solvent to form a dispersion which in some embodiments may be homogenized. The aqueous Ulva composition may be produced by mixing the Ulva in seawater or freshwater. Freshwater may be deionized water, distilled water, or distilled and deionized water. Natural acidifiers may be used to yield a solvent with a pH of about 3 to about 7. Representative examples of natural acidifiers that may be useful include citrus juices such as lemon and lime.

The amount of Ulva that is mixed with water to produce the aqueous Ulva composition may vary but generally ranges from about 1 to about 20 dry wt %, based on the total weight of the aqueous Ulva composition or from about 4 to about 10 dry wt % based on the total weight of the aqueous Ulva composition. In some embodiments, the Ulva comprises about 1 dry wt %, about 2 dry wt %, about 3 dry wt %, about 4 dry wt %, about 5 dry wt %, about 6 dry wt %, about 7 dry wt %, about 8 dry wt %, about 9 dry wt %, about 10 dry wt % based on the total weight of the aqueous Ulva composition.

The aqueous Ulva composition is subjected to heating under pressure (also referred to herein as pressure-assisted extraction) to extract gel-forming polysaccharides from the Ulva powder.

Extraction temperatures range from about 100° C. to about 135° C. In some embodiments, the heating temperature is about 100° C., about 105° C., about 110° C., about 115° C., about 120° C., about 125° C., about 130° C., about 135° C. In some embodiments, the extraction temperature is about 120° C.

Extraction pressures range from about 5 PSIG to about 30 PSIG. In some embodiments, the extraction pressure is about 5 PSIG, about 10 PSIG, about 15 PSIG, about 20 PSIG, about 25 PSIG, about 30 PSIG, or about 35 PSIG. In some embodiments, the extraction pressure is about 20 PSIG.

Extraction times may vary but generally range from about 5 to about 60 minutes. In some embodiments, the extraction time is about 5 minutes, about 10 minutes, about 15 minutes, about 20 minutes, about 25 minutes, about 30 minutes, about 35 minutes, about 40 minutes, about 35 minutes, about 40 minutes, about 45 minutes, about 50 minutes, about 55 minutes, or about 60 minutes (including subranges therein). In some embodiments, the extraction time is about 20 minutes.

Following the pressure-assisted extraction, the resultant aqueous Ulva composition may optionally be filtered and/or centrifuged to remove water-insoluble solids. The resultant aqueous Ulva composition that results from extraction may be separated from the water-insoluble solid residue using standard filtration methods, such as vacuum filtration or centrifugation. Filtration may assist the removal of any remaining debris or insoluble components. See, Prabhua et al., Algal Research 37:215-227 (2019).

Following extraction and the optional filtering and/or centrifuging, the resultant aqueous Ulva composition is cooled, thereby forming the Ulva gel composition. Cooling times may vary. For example, in some embodiments, the cooling is performed for about 1 hour to about 10 days. In some embodiments, the cooling time is about 5 hours, about 12 hours, about 1 day, about 2 days, about 3 days, about 4 days, about 5 days, about 6 days, about 7 days, about 8 days, about 9 days, or about 10 days. In some embodiments, the cooling time is about 2 days.

Cooling temperatures may also vary. For example, in some embodiments, the cooling temperature is about 2° C. to about 6° C. In some embodiments, the cooling temperature is about 2° C., about 3° C., about 4° C., about 5° C., about 6° C. In some embodiments, the cooling temperature is about 2° C.

In some embodiments, the Ulva gel has a solids content of about 0.2 wt % to about 10 wt % based on the total weight of the Ulva gel composition. In some embodiments, the Ulva gel has a solids content of about 0.2 wt %, about 0.5 wt %, about 0.75 wt %, about 1wt %, about 2 wt %, about 3 wt %, about 4 wt %, about 5 wt %, about 6 wt %, about 7 wt %, about 8 wt %, about 9 wt %, or about 10 wt %, based on the total weight of the Ulva gel composition. In some embodiments, the Ulva gel has a solids content of about 10 wt %, based on the total weight of the Ulva gel composition. Ulva solids may be measured by comparing the difference between gel weights before and after completely drying.

In addition to Ulva polysaccharides, one or more other types of Ulva solids such as Ulva proteins, fats, minerals (i.e., salts), pigments, phytochemicals, and inorganics may also be coextracted in the course of the pressure-assisted extraction, and therefore will be present in the Ulva gel composition. Representative minerals that may be present in solid Ulva constituents include calcium, potassium, and sodium. Representative fats that may be present in solid Ulva constituents include Omega-3, Omega-6, and Omega-9 fatty acids. Representative phytochemicals that may be present in solid Ulva constituents include phenolic acids, terpenoids, and alkaloids. Representative inorganics that may be present in solid Ulva constituents include iodine, magnesium, and selenium.

Gel strength is a measurement of gel rigidity. The Ulva gel strength may be tested according to Gelatin Manufacturers Institute of America (GMIA) official procedures, and expressed in bloom number, defined as gram Bloom. Gel strength is typically measured with a gelometer (e.g., a LFRA Texture Analyzer commercially available from Brookfield Engineering) equipped with a 12.70 mm diameter plunger with a plane surface and sharp edge. To measure gel strength, an Ulva gel composition is loaded into a bloom bottle. The gel is allowed to stand for about 15 to about 20 minutes at room temperature or for about 30 minutes to about 45 minutes in a 45° C. water bath. Next the bloom bottle is stirred, uncapped, and the any foam on top of the gel is removed from the center of the gel. The bloom bottle is then re-capped and is placed in a 10° C. water bath for about 16 to about 18 hours. Next the bloom bottle is removed from the water bath, uncapped, and placed on the center of the gelometer platform such that the gelometer plunger contacts the gel as close to the gel's midpoint as possible. The gel strength is then measured with the gelometer set with a plunger distance of about 4 mm and a plunger speed of about 0.5 mm/sec or about 1.0 mm/sec. See, “Standard Testing Methods for Edible Gelatin,” in Official procedures of the Gelatin Manufacturers Institute of America, Inc. pp 1-33 (2019).

In some embodiments, the Ulva gel has a gel strength of about 1 gram Bloom to about 350 gram Bloom. In some embodiments, the Ulva gel has a gel strength of about 50 gram Bloom to about 200 gram Bloom. In some embodiments, the Ulva gel has a gel strength of about 200 gram Bloom to about 3500 gram Bloom. In some embodiments, the Ulva gel has a gel strength of about 200 gram Bloom to about 250 gram Bloom. In some embodiments, the Ulva gel has a gel strength of about 250 gram Bloom. In some embodiments, the Ulva gel has a gel strength of about 250 gram Bloom to about 350 gram Bloom. In some embodiments, the Ulva gel has a gel strength of about 350 gram Bloom.

### Additives

In some embodiments, the Ulva gel contains one or more additives suitable for use in nutraceutical formulations for human use. Additives may be added for purposes of modifying properties of the Ulva gel such as moisture content, rheology, nutrition, syneresis, antioxidant activity, and bioactivity. Representative examples of additives that may be useful include flavorants, salts, colorants, preservatives, plant extracts, algal extracts, bacterial extracts, and fungal extracts. In some embodiments, the flavorant is a natural flavorant. Representative examples of natural flavorants include agave nectar, stevia extract, stevia powder, maple syrup, honey, dates, citrus products (e.g., lemon, lime, or orange juice or freeze-fried powder), fruit products (e.g., raspberries, strawberries, or blueberries, bananas, mangoes, or pineapples), vanilla extract, cinnamon, coconut milk, coconut water, cucumber juice, herbs (e.g., mint or basil leaves), spices (e.g., ginger, nutmeg, or cardamom), essential oils (e.g., food-grade peppermint or orange oils), and vinegar. In some embodiments, the natural flavorant is lemon, lime, vinegar, or a combination of two or more thereof.

Natural sweeteners may help balance the flavor profile of the Ulva gel. Citrus products may provide a tangy brightness to the Ulva gel, cutting through any potential earthy or sea-like flavors. Fruit products may infuse the Ulva gel with natural sweetness, fruity flavors and contribute additional nutrients and antioxidants. Vanilla extract may add depth and warmth to the Ulva gel, enhancing without overpowering the flavor profile. Cinnamon may add a warm, slightly spicy flavor that complements the natural taste of Ulva gel. Coconut milk/water and cucumber juice may lend a tropical flavor to Ulva gel, creating a creamy and slightly sweet base. Herbs (e.g., mint leaves or basil) may add a refreshing and aromatic taste to Ulva gel. Spices (e.g., ginger, nutmeg, or cardamom) may be added to Ulva gel for a more complex flavor profile. Food-grade essential oils (e.g., peppermint or orange) may be used in small amounts to add intense flavor to Ulva gel.

In some embodiments, the additive is a salt (i.e., mineral). Salts/minerals may affect the properties of the gel (e.g., pH, gel strength and aid in nutrient absorption and retention). Representative examples of salts that may be useful include boron, calcium chloride, sodium chloride, potassium chloride, calcium carbonate, magnesium sulfate, sodium bicarbonate, potassium nitrate, sodium sulfate, calcium carbonate, potassium hydroxide, magnesium chloride, ammonium chloride, sodium carbonate, calcium phosphate, potassium sulfate, magnesium carbonate, potassium carbonate, calcium sulfate, ammonium nitrate, and sodium nitrate. In some embodiments, the salt is a boron salt. In some embodiments, the boron salt is sodium borate (Na₂B₄O₇), sodium tetraborate (Na₂B₄O₇), potassium borohydride (KBH₄), or calcium fructoborate (C₂₄H₄₀B₂CaO₂₄). The amount of salt(s) that may be added to the aqueous Ulva composition or the Ulva gel composition ranges generally from about at about 0.001 wt % to about 1 wt %, based on the total weight of the aqueous Ulva composition or the Ulva gel composition, respectively. In some embodiments, the amount of salt(s) may be in an amount of from about 0.01 wt % to about 0.5 wt %, and in some embodiments, from about 0.05 wt % to about 0.5 wt %, and in some embodiments, 0.1 wt % to about 0.5 wt %, based on the total weight of the Ulva gel composition.

In some embodiments, the additive is a boron-containing compound. In some embodiments, the boron-containing compound is an inorganic borate, a mono-sugar-borate ester, or di-sugar-borate ester. In some embodiments, the boron-containing compound is boron ascorbate (C₁₈H₂₁BO₁₈), boron aspartate (C₁₂H₁₅B₂N₃O₁₂), boron gluconate (C₆H₁BO₈), boron picolinate (C₁₈H₁₂CrN₃O₆), boron citrate (C₆H₅BO₇), or boron glycinate (C₂H₄BNO₂). In some embodiments, the amount of the boron-containing compound or the boron salt of a boron-containing compound ranges from about 0.001 wt % to about 0.05 wt %, based on the total weight of the Ulva gel composition.

In some embodiments, the additive is a colorant. Colorants may affect the properties of the gel (e.g., rigidity, gel strength, nutritional benefit, decorative, and/or ornamental properties). Colorants may be natural or synthetic. Natural colorants may be from any natural source, including seaweed. In some embodiments, the colorant is a natural pigment. In some embodiments, the natural pigment is from Ulva and/or another seaweed. In some embodiments, the natural pigment is from a plant-based source. In some embodiments, the natural pigment is from one or more of spinach, beetroot, and blackberries.

In some embodiments, the colorant is included in a decolored Ulva gel composition that contains no Ulva pigments. In some embodiments, the colorant is added to an Ulva composition that has not had Ulva pigments removed, which are referred to as color supplemented Ulva gel compositions. Embodiments in which an Ulva gel composition does not contain a colorant as an additive, and wherein the Ulva pigments were removed are substantially colorless or substantially transparent.

Plant and microbial extracts may be obtained from any plant or microbe known to contain substances that support good health and overall wellness. In addition to these types of substances, the extract may also provide enhanced organoleptic and solubility properties of the Ulva gel composition. Plant extracts are obtainable from leaves, oils, roots, seeds, berries, and/or flowers. In some embodiments, the plant extract is obtainable from burdock (Arctium species) black pepper, soy (e.g., lecithin and glycerol), coconut, palm, marigold (Calendula officinalis), oak (Quercus robur), white willow (Salix alba), witch-hazel (Hamamelis virginiana), and ginger (Zingiber officinale). In some embodiments, the algal extract is obtainable from a blue-green algae (e.g., spirulina) and bladderwrack (Fucus vesiculosis). In some embodiments, the bacterial extract is obtainable from Aphanizomenon flos-aquae. In some embodiments, the fugal extract is obtainable from lion's mane, turkey tail, or chana.

The additives may be incorporated into the Ulva gel composition in any order. In some embodiments, additive(s) is/are incorporated after extraction. The additive(s) may be added before, during, or after gelation of the aqueous Ulva composition. In some embodiments, the additive(s) is/are added after the gel is formed, and before, during, or after cooling. In some embodiments, the additive(s) is/are added before the extraction and are present during the extraction of Ulva gels.

The amount of total additive(s) present in the Ulva gel composition may vary, and generally may be in an amount of from about 0.01 wt % to about 10 wt %, and in some embodiments, from about 2 wt % to about 5, wt %, and in some embodiments from about 0.1 wt % to about 2 wt %, based on the total weight of the Ulva gel composition.

### Nutraceuticals

The Ulva gel compositions may have various industrial uses. In one aspect, the Ulva gel may be used (i.e., consumed or otherwise applied to a body) as a nutraceutical on account of its mineral, vitamin, and antioxidant content. Although not federally regulated, it is known in the art that nutraceuticals may provide one or more health or overall wellness benefits. The Ulva gels described herein may inherently be a nutraceutical, without additional additives. Nutraceuticals may be prepared using known additives and preparation techniques for gels.

In some embodiments, the nutraceutical is formulated for topical use, either alone, or in an admixture. Representative examples of topical formulations that contain the Ulva gel may include creams, ointment, pastes, lotions, and sachets. Creams are an emulsion of water and oil and may contain emulsifiers and preservatives. Types of creams include, for example, oil-in-water (O/W) creams and water-in-oil (W/O) creams depending on the percentages of oil and water in the cream. Ointments are a semi-soil preparation of hydrocarbons (e.g., petrolatum, mineral oil, paraffins, synthetic hydrocarbons). Ointments do not contain added water, nor do they require preservatives. Pastes are semi-solid mixtures of powder and ointment. Lotions include any liquid preparation in which inert or bioactive ingredients are suspended or dissolved. Additional topical formulations are known in the art. See, for example U.S. Pat. Nos. 6,680,062, 8,529,925, 9,737,476, and 10,653,614, and Flick, Cosmetic and Toiletry Formulations Volume 2, 2^{nd} edition, Noyes Publications, pp. 1-987, (1992), Park Ridge, New Jersey United States of America.

In some embodiments, the nutraceutical is formulated for ingestible use. Representative examples of ingestible formulations useful with the Ulva gel may include pills, gummies, drops, drink blends, oils, capsules, caplets, sprinkle capsules, softgels, or tablets. In some embodiments, the tablets are chewable tablets, oral disintegrating tablets, sublingual tablets, effervescent tablets, or buccal tablets. Liquid formulations (e.g., drops and drink blends) may be produced by mixing the Ulva gel with a solvent, e.g., water. Oil formulations may be produced by mixing the Ulva gel with an oil. Representative examples of oils that may be useful include vegetable oils, including olive oil, coconut oil, avocado oil, canola oil, rapeseed oil, grapeseed oil, and essential oils. Additional ingestible formulations are known in the art. See, for example, DeMars and Ziegler, Food Hydrocolloids 15:643-653 (2001), Burey et al., International Journal of Food Properties 12:176-210 (2009), Hull, Glucose Syrups: Technology and Applications. United Kingdom: Wiley, pp. 1-368, (2010), Helal et al., Recent Pat. Drug. Deliv. Formul. 13(2):105-156 (2019), Habilla et al., International Food Research Journal, 18:213-220 (2011), Cassano et al., Gels 7(3):130 (2021), and Tireki et al., J. Food Sci. Technol. 58(9):3397-3408 (2021).

In some embodiments, the nutraceutical consists of the Ulva gel, i.e., as is, without additives. In some embodiments, the nutraceutical has a serving size of about 1 tablespoon or about 2 tablespoons. In some embodiments, the nutraceutical has a serving size of about 20 g, 22.5 mL, 25 g, about 27.5 g, or about 30 g. In some embodiments, the nutraceutical has a serving size of about 20 mL, 22.5 mL, 25 mL, 27.5 mL, or about 30 mL.

### Containers

In one aspect, the disclosure provides a container containing the Ulva gel composition or the nutraceutical described above. In some embodiments, the container is a jar, bag, or tube.

These and other aspects of the present application will be further appreciated upon consideration of the following Examples, which are intended to illustrate certain embodiments of the application but are not intended to limit its scope, as defined by the claims.

### EXAMPLES

### Example 1: Effect of Ulva Loading, Extraction Method, and Ulva Batch Variations

The impact of Ulva ohnoi loading, extraction methods, and batch variations was investigated. Four Ulva loading conditions were examined, ranging from 4-8 dry wt % based on the total weight of the aqueous Ulva composition (i.e., grams Ulva/g solvent). The extractions were conducted using completely aqueous methods without additives. Two extraction techniques were employed: 1) boiling aqueous Ulva compositions for 60 minutes and 2) autoclaving aqueous Ulva compositions using default settings.

Autoclaving involved a “20-minute cycle,” reaching a full temperature of 115° C. under pressure for 20 minutes. Experimental conditions for each trial are detailed in Table 1. Following extraction, the gel was separated from particulates through centrifugation and allowed to set by cooling at 2° C. for two days. Gel strength was determined using a load cell and a hand-operated press, recording the peak force when the press depressed into the gel by 5 millimeters.

TABLE 1
Experimental conditions of each trial for studying the effects of
Ulva ohnoi loading, extraction method, and batch variations.

| | | Ulva | | |
|---|---|---|---|---|
| | Harvest | Loading | Extraction | Temperature |
| Batch Code | Month | (dry wt %) | Time (m) | (° C.) |
| 20823GU800 | July | 4 | 60 | 95 |
| 20823GU800 | July | 6 | 60 | 95 |
| 20823GU800 | July | 8 | 60 | 95 |
| 20823GU800 | July | 10 | 60 | 95 |
| 20823GU800 | July | 4 | 20 | 120 |
| 20823GU800 | July | 6 | 20 | 120 |
| 20823GU800 | July | 8 | 20 | 120 |
| 20823GU800 | July | 10 | 20 | 120 |
| 08623GU800 | March | 4 | 60 | 95 |
| 08623GU800 | March | 6 | 60 | 95 |
| 08623GU800 | March | 8 | 60 | 95 |
| 08623GU800 | March | 10 | 60 | 95 |
| 08623GU800 | March | 4 | 20 | 120 |
| 08623GU800 | March | 6 | 20 | 120 |
| 08623GU800 | March | 8 | 20 | 120 |
| 08623GU800 | March | 10 | 20 | 120 |

The term “relative” in peak force considered factors such as gel volume, container, probe geometry, and depression rate. All samples underwent analysis under identical conditions for consistency in this study.

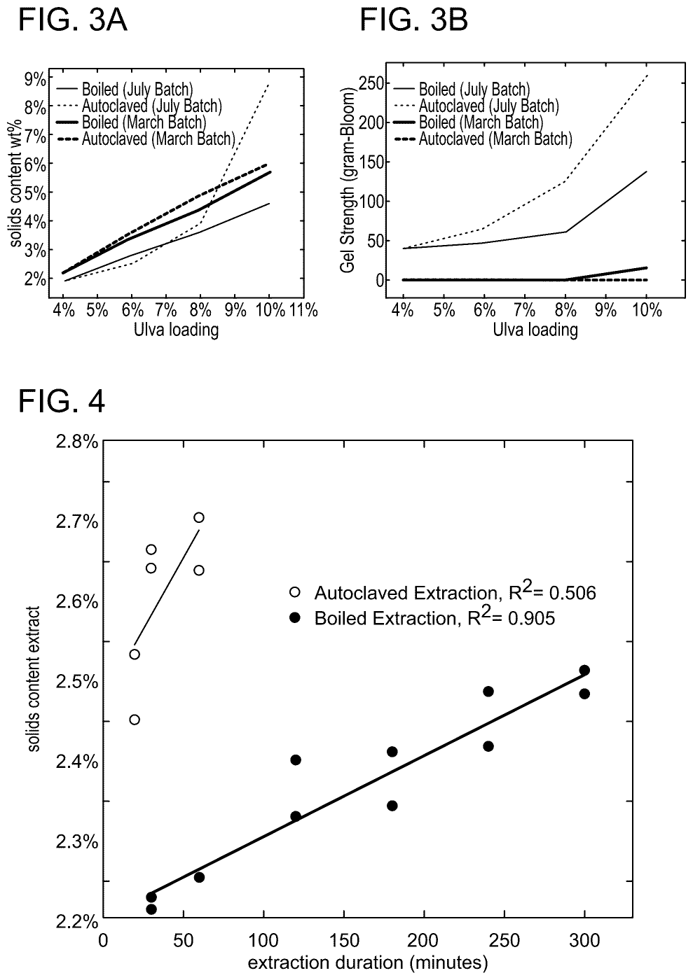

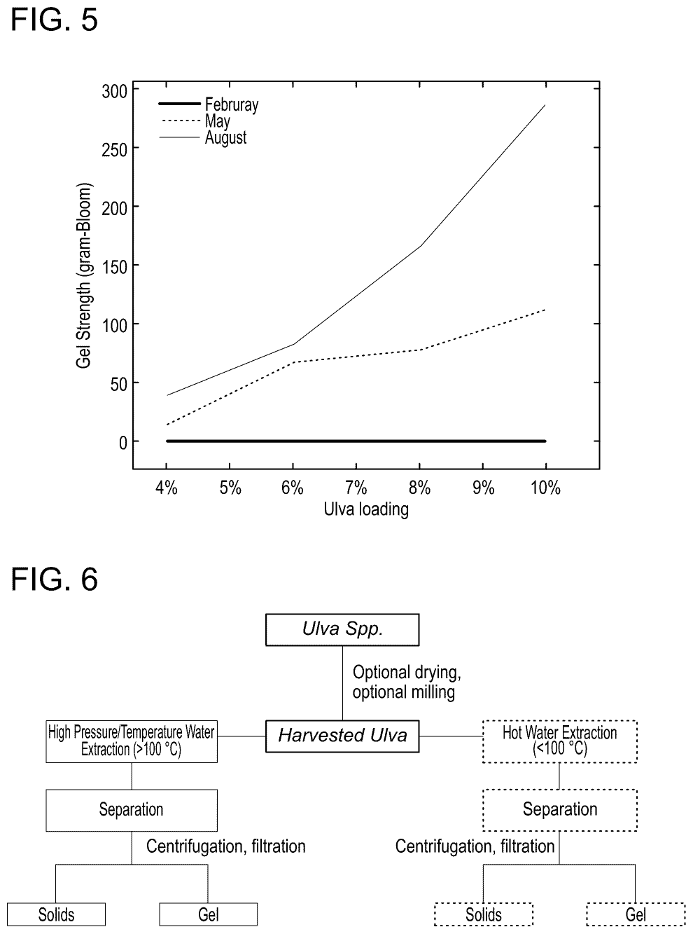

The study investigated the total solids content of seaweed gels, finding significant variation among batches. March batches had higher extractable solids but minimal gelling capacity, while July batches exhibited strong gels (FIGS. 3A-3B). Autoclaving improved gel strength compared to boiling, indicating, without being bound by theory, pressure-assisted extraction resulted in superior gel-participating polysaccharides as compared to boil extraction. Acid extractions are ineffective for gel formation as they degrade polymers. High-pressure aqueous extractions, like autoclaving, may be crucial for extracting valuable gel-forming material without significant polymer degradation.

### Example 2: Effects of Extraction Duration on Solid Content Yield

Extraction yields were determined gravimetrically for extracts (Ulva ohnoi powder from July 2023 batch) obtained from boiling and autoclaving over times ranging from 20 to 300 minutes. All trials were conducted at 5 dry wt % Ulva powder loading, and gel strength tests were not conducted. All trials were performed in duplicate.

Autoclaving increases extract solids content by 10-20%, surpassing boiling for 5 hours (FIG. 4). High-pressure/temperature extractions offer energy efficiency, justifying higher equipment costs. Discrepancies in solids content compared to previous results are attributed to experimental error. Gel strength tests were not conducted, limiting the translation of improved solids extraction to gel performance assessment in these trials.

### Example 3: Batch versus Gel Strength

Each experiment was autoclaved on a “20-minute” cycle with Ulva powder loading from 4-10 dry wt %. All extractions were performed in deionized water with no additives to the aqueous Ulva composition. Each trial was extracted at 120° C. for 20 minutes. Experimental conditions, resulting solids extraction, and gel strength for each trial are listed in Table 2. Gel strength was measured in Newtons (N).

TABLE 2
Experimental conditions of each trial investigating the
differences in extractable solids and gel strength.

| | | Ulva | Solids | |
|---|---|---|---|---|
| | Harvest | Loading | content | Gel Strength |
| Batch Code | Month | (dry wt %) | (%) | (Bloom) |
| 03520GU800 | February | 4 | 3.25 | 0 |
| 03520GU800 | February | 6 | 4.97 | 0 |
| 03520GU800 | February | 8 | 6.8 | 0 |
| 03520GU800 | February | 10 | 8.25 | 0 |
| 13021GU600 | May | 4 | 3.61 | 15 |
| 13021GU600 | May | 6 | 4.76 | 67 |
| 13021GU600 | May | 8 | 6.52 | 78 |
| 13021GU600 | May | 10 | 8.04 | 112 |
| 20220GU800 | July | 4 | 3.34 | 39 |
| 20220GU800 | July | 6 | 4.53 | 83 |
| 20220GU800 | July | 8 | 6.18 | 166 |
| 20220GU800 | July | 10 | 7.41 | 287 |

This study emphasizes the large variations in gelling capacity between batches. As expected, higher-Ulva powder loading contents yield the strongest gels. Surprisingly, the oldest gel yields a suitably strong gel, suggesting that the powders are relatively stable, provided that they are stored correctly.

### Example 4: Harvest Season versus Gel Strength

Correlations may exist between season and relative gelling strength (capacity) at Ulva loading at 4, 6, and 8 dry wt %, based on the total weight of the water/aqueous Ulva composition. Gels strengths are reported on a qualitative scale between 0 and 3. “0” indicates no gelling and “3” indicates a strong, freestanding gel. Rankings “1” and “2” indicate weak and moderate strength gels, respectively.

| | | Relative gel strength | | |
|---|---|---|---|---|
| Batch Code | Harvest Month | 4% | 6% | 8% |
| 32319GU800 | July | 2 | 3 | 3 |
| 22320GU800 | August | 2 | 3 | 3 |
| 345203D0221 | December | 0 | 0 | 0 |
| 01221GU80-0 | January | 0 | 1 | 2 |
| 04621GU800 | February | 2 | 3 | 3 |
| 08921GU800 | March | 0 | 0 | 0 |
| 105213D0042 | April | 2 | 3 | 3 |
| 22121GU800 | August | 1 | 2 | 3 |
| 36421GU800 | December | 0 | 0 | 0 |
| 013223D0008 | January | 0 | 0 | 0 |
| 10122GU800 | April | 0 | 0 | 0 |
| 22722GU600 | August | 2 | 2 | 3 |
| 004233D0003 | January | 0 | 0 | 0 |
| 07923GU600 | March | 0 | 0 | 0 |
| G3 CONTROL-2 | November | 2 | 3 | 3 |
| G3 CONTROL | December | 0 | 0 | 0 |

This study emphasizes the variations in gelling capacity and strength between batches. In general, higher-Ulva powder loading contents yield the strongest gels. This study emphasizes the large variations in gelling capacity between batches. As expected, higher-Ulva powder loading contents yield the strongest gels. Surprisingly, the oldest gel yields a suitably strong gel, suggesting that the powders are relatively stable, provided that they are stored correctly.

### Example 5: Deodorizing

Various techniques were explored to address the challenge of intense marine odor in Ulva gel products, including UV bleaching, peroxide bleaching, chlorine bleaching, ethanol pretreatment, and natural flavor enhancers like lemon, lime, and vinegar. Chemical and UV bleaching were deemed impractical due to energy requirements and toxicity. Ethanol pretreatment showed consistent and noticeable improvements in aroma, with the addition of lemon and lime as flavor enhancers ranking as the most tolerable. Ethanol pretreatment also yielded co-extracted pigments, fatty acids, and other valuable small molecules, offering supplementary streams to enhance the marketability of Ulva Gel products.

All patent publications and non-patent publications are indicative of the level of skill of those skilled in the art to which this disclosure pertains. All these publications are herein incorporated by reference to the same extent as if each individual publication were specifically and individually indicated as being incorporated by reference.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

What is claimed is:

1. An Ulva composition in the form of a gel, wherein the gel is made by a process comprising:
a. mixing Ulva with water thereby producing an aqueous Ulva composition, wherein the Ulva comprises at least about 1 dry weight percent (wt %) based on the total weight of the aqueous Ulva composition;
b. heating the aqueous Ulva composition at a temperature of about 100° C. to about 135° C., and at a pressure of about 5 pounds per square inch gauge (PSIG) to about 30 PSIG;
c. optionally filtering and/or centrifuging the resultant aqueous Ulva composition; and
d. cooling the aqueous Ulva composition of step (b) or (c), thereby forming the Ulva gel composition.

2. The composition of claim 1, wherein the Ulva is Ulva lactura.

3. The composition of claim 1, wherein the Ulva is harvested from a natural maritime source.

4. The composition of claim 1, wherein the Ulva is freshly harvested.

5. The composition of claim 1, wherein the Ulva in (a) is in dry form, powder form, or flaked.

6. The composition of claim 1, wherein the Ulva is stored after harvesting but prior to (a).

7. The composition of claim 6, wherein the Ulva is stored at about room temperature.

8. The composition of claim 6, wherein the Ulva is stored for a time period of about 1 week to about 3 years.

9. The composition of claim 1, further comprising (e) treating the Ulva with ethanol prior to (a); or
further comprising (f) homogenizing the aqueous Ulva composition prior to (b); or
wherein the process comprises (c) filtering and/or centrifuging after (b) prior to (d).

10. The composition of claim 1, wherein the Ulva comprises from about 1 to about 14 dry wt % based on the total weight of the aqueous Ulva composition.

11. The composition of claim 1, wherein the heating is conducted at a temperature of about 120° C.; or
wherein the heating is conducted at a pressure of about 20 PSIG; or
wherein the heating is conducted for about 20 to about 60 minutes.

12. The composition of claim 1, wherein the cooling is conducted at a temperature from about 2° C. to about 6° C.

13. The composition of claim 1, wherein the cooling is conducted for a time of about 1 hour to about 10 days.

14. The composition of claim 1, further comprising an additive.

15. The composition of claim 14, wherein the additive is a flavorant, a salt, a colorant, a preservative, a plant extract, an algal extract, a bacterial extract, or a fungal extract.

16. The composition of claim 15, wherein the flavorant is lemon, lime, vinegar, or a combination of two or more thereof.

17. The composition of claim 15, wherein the salt comprises a boron salt, calcium chloride, sodium chloride, potassium chloride, calcium carbonate, magnesium sulfate, sodium bicarbonate, potassium nitrate, sodium sulfate, calcium carbonate, potassium hydroxide, magnesium chloride, ammonium chloride, sodium carbonate, calcium phosphate, potassium sulfate, magnesium carbonate, potassium carbonate, calcium sulfate, ammonium nitrate, sodium nitrate, or a combination of two or more thereof.

18. The composition of claim 1, wherein the Ulva gel has solids content of about 0.2 to about 10% based on the total weight of the composition.

19. The composition of claim 1, wherein the Ulva gel has a gel strength of about 1 to about 350 gram Bloom.

20. A nutraceutical comprising the Ulva gel composition of claim 1.

21. The nutraceutical of claim 20, which is in a formulation suitable for topical use; or which is in a formulation suitable for ingestible use.

22. The nutraceutical of claim 21, wherein the formulation is a cream, an ointment, a paste, or a lotion; or wherein the formulation is a pill, a gummy, a capsule, a caplet, a sprinkle capsule, a softgel, or a tablet.

23. A container comprising the Ulva gel composition of any one of claim 1, or a nutraceutical comprising the Ulva gel composition of claim 1.

24. The container of claim 23, which is a jar, a bag, or a tube.

25. A process of producing an Ulva composition in the form of a gel, comprising:
a. mixing Ulva with water thereby producing an aqueous Ulva composition, wherein the Ulva comprises at least about 1 dry wt % based on the total weight of the water;
b. heating the aqueous Ulva composition at a temperature of about 100° C. to about 135° C., and at a pressure of about 5 PSIG to about 30 PSIG;
c. optionally filtering and/or centrifuging the resultant aqueous Ulva composition; and
d. cooling the aqueous Ulva composition of step (b) or (c), thereby forming the gel composition.
